(19) United States
(12) Patent Application Publication
(10) Pub. No.: US 2017/0337301 A1
(43) Pub. Date: Nov. 23, 2017

(54) SOFTWARE AND METHODS FOR BUILDING, SHARING AND ORDERING A CUSTOMIZED STORAGE CART

(71) Applicant: Trinity International Industries, LLC, Carson, CA (US)

(72) Inventors: CZE-CHAO TAM, Palos Verdes, CA (US); JERRY CHIAO, Fremont, CA (US)

(73) Assignee: Trinity International Industries, LLC, Carson, CA (US)

(21) Appl. No.: 15/161,072

(22) Filed: May 20, 2016

(51) Int. Cl. G06F 17/50

(52) U.S. Cl. CPC G06F 17/5009; G06F 17/5086

(57) ABSTRACT

Storage solutions are easily designed, configured, edited, shared with others and ordered on a single software application custom designed for this purpose. The software application may reside on an electronic computing device. The software application can include a configuration module for designing the storage solution, a sharing module for sharing the design with others, and an ordering module for ordering the customized storage solution. The configuration module permits the user to enter desired dimensions of the cart and then fill those dimensions with a plurality of components, such as drawers, cabinets, open shelves, and the like. The storage solution may be a storage cart having a top surface and optional wheels.

### BACKGROUND OF THE INVENTION

### 1. Field of the Invention

One or more embodiments of the invention relates generally to storage solutions. More particularly, the invention relates to systems and methods for building, sharing and ordering a customized storage solution, such as a storage cart.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many different types of spaces exist in residential homes and businesses where a storage solution would improve utilization of the space. These spaces can have various sizes or may have different storage requirements. For example, in some locations, it may be desirable to have long, shallow drawers, where in other locations, it may be desirable to have shorter, deeper drawers. Often, it is difficult to find a commercially available storage solution that precisely fits the needs of the consumer.

One option is to employ a custom cabinet maker to design and install a custom-made cabinet into the desired space. This approach, however, can be costly while also requiring significant wait time before the storage solution is completed.

Other options include computerized options for fitting cabinets into a desired space. Some of these computerized options focus on selecting cabinets from a selection of predetermined sizes to fit into a given space. Other computerized options focus on a particular environment, such as office cubicle design or closet design.

When configuring a storage solution for a workshop or garage, the configuration options may vary significantly depending on the user's needs. For example, a wood carver may have a need to store more small hand tools, while an auto mechanic may have a need for storing larger tools and supplies. Tool chest manufacturers try to address this need by making such tool chests with drawers of multiple sizes, often with the shortest height drawers at the top and the deepest drawers at the bottom. These tool chests, however, are often offered in one or limited widths. Moreover, while various modules of drawers are available for purchase and, thus, can be stacked or arranged by the user, there is no way to customize a storage cart to provide an integrated, customized storage solution for a given user.

In view of the foregoing, it is clear that there is a need for a system and method for designing, sharing and ordering a customized storage solution.

### SUMMARY OF THE INVENTION

Embodiments of the present invention provide a method for designing a storage solution comprising entering desired dimensions for the storage solution into a software application running on a computing device; choosing, on a display of the computing device, from a plurality of components selected to fit into the desired dimensions, the plurality of components including one or more drawers, one or more cabinets, one or more open shelves, or combinations thereof; viewing a completed, designed storage solution on the display; optionally sharing the completed, designed storage solution with select recipients by electronically sending an image thereof; and optionally ordering, on the software application, the completed, designed storage solution.

Embodiments of the present invention further provide a method of designing, sharing and ordering a storage solution comprising accessing a software application on a computing device, the software application having a configuration module, a sharing module and an ordering module; designing the storage solution in the configuration module, the designing step showing the storage solution on a display thereof during its design, the configuration module including an editing submodule allowing a user to edit a design by adding or removing features therefrom; sharing a customized storage solution with others via the sharing module, the sharing module permitting sharing via at least one of text message and social media post; and ordering the customized storage solution via the ordering module. Embodiments of the present invention also provide a system for customizing, sharing and ordering a storage solution on an electronic computing device comprising a client module resident on the electronic computing device of a user, comprising a non-transitory computer readable memory having computer readable program code embodied therewith, the computer readable program code including a configuration module for designing the storage solution, the configuration module showing the storage solution on a display of the electronic computing device during its design, the configuration module including an editing submodule allowing a user to edit a design by adding or removing features therefrom; a sharing module for sharing a designed customized storage solution with others, the sharing module permitting sharing via at least one of text message and social media post; and an ordering module for ordering the designed customized storage solution from within the client module.

The methods and systems of the present invention can further include a parts database accessible by the configuration module, the parts database including each available option for designing the storage solution.

The methods and systems of the present invention can apply to various storage solutions, such as a storage cart having a top surface and a plurality of wheels.

In the configuration module, a user may be able to enter a desired size of the storage solution, including size options for at least one of the storage solution's length, depth and height.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates an exemplary screen shot showing use of a software application for designing, sharing and ordering a customized storage solution according to an exemplary embodiment of the present invention;

FIG. 2 illustrates an exemplary screen shot of a storage solution customization screen on a software application for designing, sharing and ordering a customized storage solution according to an exemplary embodiment of the present invention;

FIG. 3 illustrates an exemplary screen shot of a sharing screen on a software application for designing, sharing and ordering a customized storage solution according to an exemplary embodiment of the present invention;

FIG. 4 illustrates an exemplary method for designing, sharing and ordering a customized storage solution according to an exemplary embodiment of the present invention; and

FIG. 5 illustrates an exemplary electronic device that can be used to configure, share and order a customized storage solution.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Web sites comprise a collection of connected, or otherwise related, webpages. The combination of all the web sites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, and the like.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

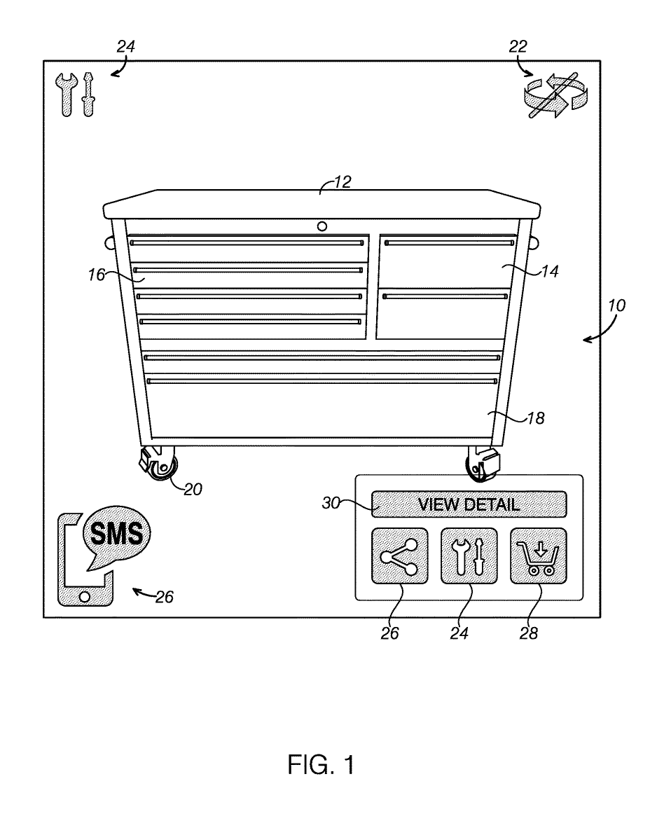

FIG. 1 illustrates an exemplary screen shot of a main screen displayed by a software application for configuring, sharing and ordering a storage solution 10 (also referred to as a storage cart 10) in accordance with an embodiment of the present invention. The main screen may include an image of a storage solution 10, for example, a storage cart that has already been configured by the user. The storage solution 10 can include, for example, short, deep drawers 14, long, shallow drawers 16 and long, deep drawers 18. Of course, other configurations of drawers are included within the scope of the present invention. As will be discussed below, a user can select shallow drawers, such as the long, shallow drawers 16, that are longer or shorter than what is shown in the Figure. The drawers 14, 16, 18 can be contained under a top surface 12. In some embodiments, the storage cart 10 can include wheels 20 to assist in movement thereof. The wheels 10 can include features such as swivel and lock, for example.

The main screen can include various control features thereupon. For example, the main screen can include a configuration link 24, a share link 26 and an ordering link 28. The main screen may also include a detail link 30 that allows the user to view the details of a configured storage cart 10. Finally, the main screen may include a three-dimensional display button 22, permitting the user to rotate the image of the storage cart 10.

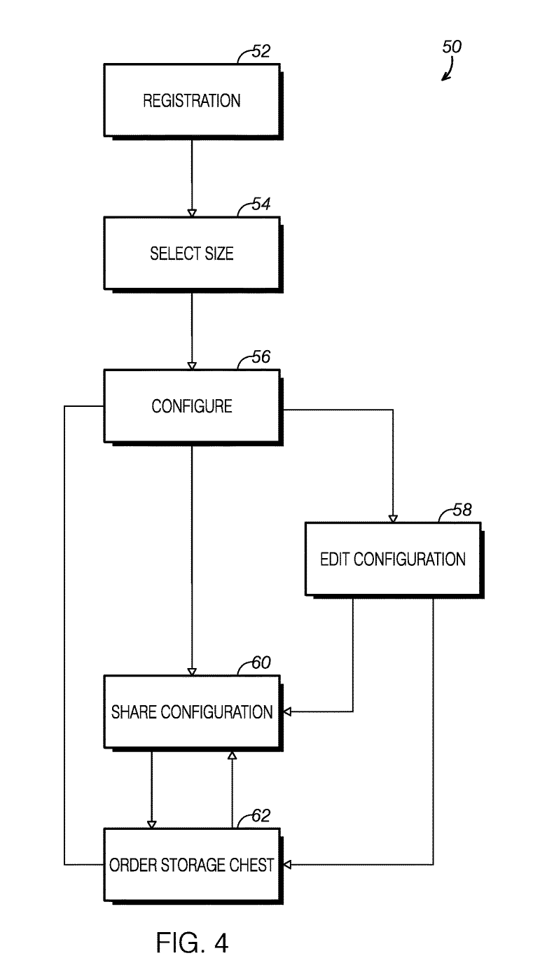

Referring additionally to FIG. 4, to access the main page shown in FIG. 1, a user can follow a method 50 for customizing, sharing and ordering the storage cart 10. The user first needs to obtain the software application on their computing device. This may be achieved by various manners known in the art. In some embodiments, the user may access an internet web page for implementing the software.

The method 50 includes a first step 52 of registration. A user is typically required to register information about themselves to access the software application. In some embodiments, a user may access the software application as a “guest”, without the need for registration.

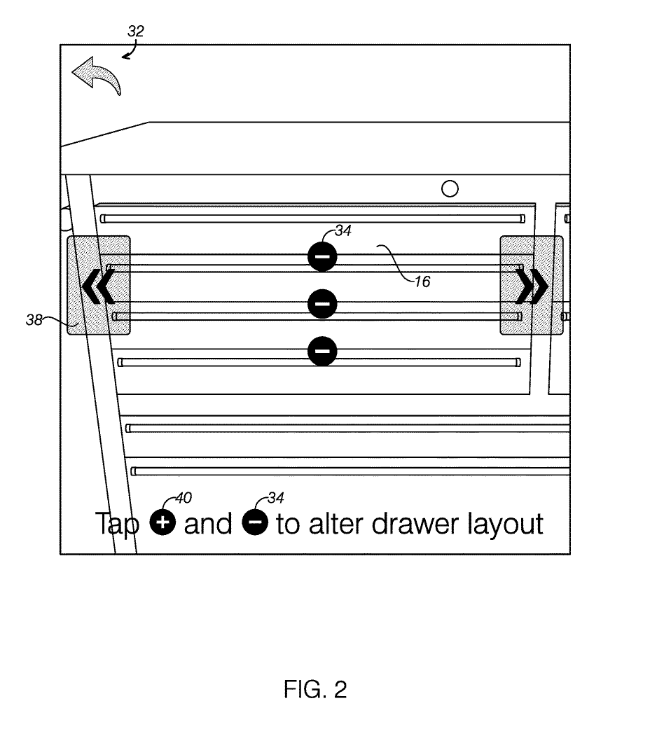

Once registered, the user may view the main screen of FIG. 1, or, in some embodiments, if the user has not yet started a project under their registration, the user may be directed immediately to a customization screen as shown in FIG. 2. Regardless of the screen, at this step 54, the user can select the desired size of their storage cart 10. In some embodiments, the size may include a length (from left to right in FIG. 1), a depth (from front to back in FIG. 1), and a height (from the wheels 20 to the top surface 12). In some embodiments, the user may be limited to one or more of these size selections.

Once a size selection is made by the user in step 54, the user can configure their storage cart 10 in step 56. As shown in FIG. 2, an exemplary configuration screen can include a way for a user to add or remove drawers, for example, by the user of add buttons 40 or remove buttons 34. Scroll buttons 38 may also be present in the configure screen to allow the user to move about their storage cart 10. In some embodiments, the entire storage cart 10 is shown on the screen with add buttons 40 or remove buttons 34 at each customizable feature.

In some embodiments, the configure step 56 may rely on a database that may be downloaded to the computing device running the software, or may be accessed by the computing device. This database may include each available option, such as drawer height and width, cabinet options, and the like. When a user begins to configure their storage cart, they may be able to view available options from the database. As the customization continues, the options shown to the user may reduce such that only options that will fit into the remaining space of the storage cart may be displayed. A company may adjust this database depending on inventory, supply changes, and the like.

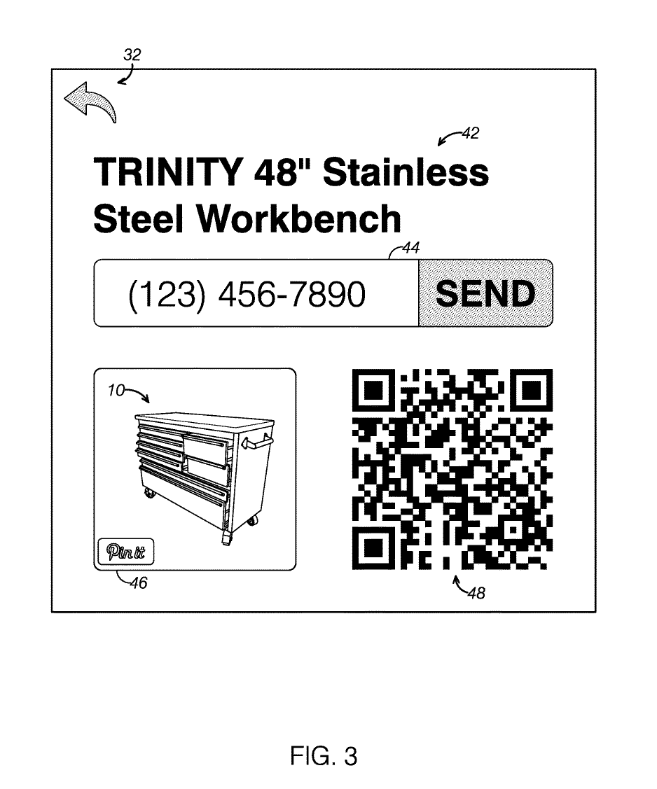

Once the user builds their storage cart 10, they may have the opportunity to further edit their configuration at step 58, or return to the main screen via a return button 32. If no edits are needed, the user may view a share screen as shown in FIG. 3 and as depicted in step 60 of FIG. 4.

The share screen may show a general description 42 of the storage cart 10. The user can have various options to share their custom designed, integrated storage cart 10. The user may be provided with a bar code link, such as a two-dimensional bar code link 48. This link may take a person to an internet address that shows the user's custom designed storage cart 10. The user may be provided with a texting box 44 to insert a phone number. A text, such as an SMS message, may be sent to the number in the texting box 44, with a picture attachment showing the custom designed storage cart 10. A social media sharing box 46 may be provided for the user to pin their custom designed storage cart 10 picture to various social media sites. A return button 32 on the share screen may return the user to the main screen as shown in FIG. 1.

In some embodiments, the user can skip the sharing step 60 and can order the storage cart 10 directly through the software application in step 62. Thus, the present invention provides a single software solution that integrates designing, customizing, editing, sharing and ordering a storage cart.

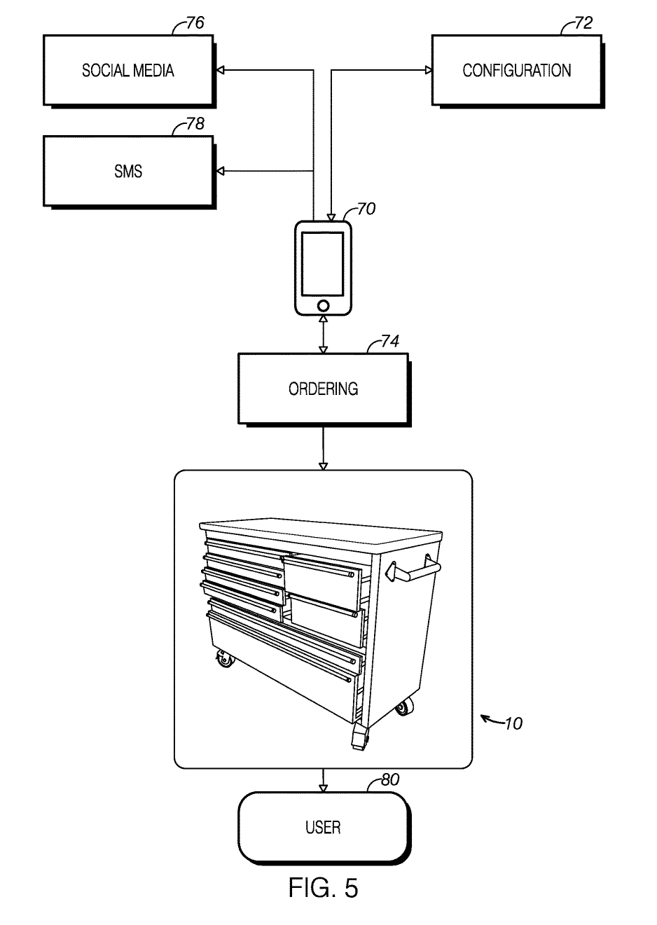

Referring now to FIG. 5, there is shown a method from a system component perspective. An electronic computing device 70 may include a processor for implementing computer code stored in the computing device 70 on tangible computer readable media. The computer code may include a configuration module 72 that permits configuration of the storage cart 10. The configuration module 72 may be integrated into the software on the electronic computing device 70 and may also include databases integrated into or remote form the electronic computing device 70. The ordering module 74 may be built into the software that permits a user to order their custom designed storage cart. Once ordered, the storage cart 10 can be delivered to the user 80. Prior or after ordering and/or delivery, the user may share their storage cart design via various sharing mechanisms, such as SMS message 78, social medial 76, or the like.

In some embodiments, the electronic computing device 70 may access the various software component via an internet web browser. In this embodiment, so or all of the software may not reside directly on the electronic computing device 70. However, from a user's perspective, the user will still have the opportunity to design, customize, share and order their storage cart via an internet / web interface.

The end product, the storage cart 10, is typically an integrated storage cart, having a plurality of drawers 14, 16, 18, a top surface 12 and, often, wheels 20. The storage cart 10 may include other features, such as drawer locks, cabinets, and the like.

The software application for customizing, sharing and ordering a storage cart can include other features not described above. For example, the software may provide a method for a user to save their storage cart design, to clear their design and start over, to save all of their ordered carts, to recall and edit saved cart designs, and the like.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for designing a storage solution comprising:
entering desired dimensions for the storage solution into a software application running on a computing device;
choosing, on a display of the computing device, from a plurality of components selected to fit into the desired dimensions, the plurality of components including one or more drawers, one or more cabinets, one or more open shelves, or combinations thereof;
viewing a completed, designed storage solution on the display;
optionally sharing the completed, designed storage solution with select recipients by electronically sending an image thereof; and
optionally ordering, on the software application, the completed, designed storage solution.

2. The method of claim 1, further comprising editing the completed, designed storage solution on the display by removing from and adding to the plurality of components.

3. The method of claim 1, further comprising a parts database from which the plurality of components is selected.

4. The method of claim 1, wherein the storage solution is a storage cart having a top surface and a plurality of wheels.

5. The method of claim 1, wherein the step of entering desired dimensions allows the user to customize at least one of a length, depth and height of the storage solution.

6. A method of designing, sharing and ordering a storage solution, the method comprising:
accessing a software application on a computing device, the software application having a configuration module, a sharing module and an ordering module;
designing the storage solution in the configuration module, the designing step showing the storage solution on a display thereof during its design, the configuration module including an editing submodule allowing a user to edit a design by adding or removing features therefrom;
sharing a customized storage solution with others via the sharing module, the sharing module permitting sharing via at least one of text message and social media post; and
ordering the customized storage solution via the ordering module.

7. The method of claim 6, wherein the configuration module accesses a parts database, the parts database including each available option for designing the storage solution.

8. The method of claim 6, wherein the storage solution is a storage cart having a top surface and a plurality of wheels.

9. The method of claim 6, wherein the configuration module includes a desired size input.

10. The method of claim 9, wherein the desired size input allows a user to customize at least one of a length, depth and height of the storage solution.

11. A system for customizing, sharing and ordering a storage solution on an electronic computing device, the system comprising:
a client module resident on the electronic computing device of a user, comprising a non-transitory computer readable memory having computer readable program code embodied therewith, the computer readable program code including:
a configuration module for designing the storage solution, the configuration module showing the storage solution on a display of the electronic computing device during its design, the configuration module including an editing submodule allowing a user to edit a design by adding or removing features therefrom;
a sharing module for sharing a designed customized storage solution with others, the sharing module permitting sharing via at least one of text message and social media post; and
an ordering module for ordering the designed customized storage solution from within the client module.

12. The system of claim 11, further comprising a parts database accessible by the configuration module, the parts database including each available option for designing the storage solution.

13. The system of claim 11, wherein the storage solution is a storage cart having a top surface and a plurality of wheels.

14. The system of claim 11, wherein the configuration module includes a desired size input.

15. The system of claim 14, wherein the desired size input allows a user to customize at least one of a length, depth and height of the storage solution.
